(19) United States
(12) Patent Application Publication
(10) Pub. No.: US 2010/0111630 A1
(43) Pub. Date: May 6, 2010

(54) TOOL AND TOOL CORRECTION METHOD

(76) Inventor: Kou Yamagishi, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/596,560

(22) PCT Filed: Apr. 22, 2009
(86) PCT No.: PCT/JP2008/057725

§ 371 Date: Oct. 19, 2009

(30) Foreign Application Priority Data
Apr. 23, 2007 (JP) 2007-112886

(51) Int. Cl. B23Q 17/22; B23Q 17/24

(52) U.S. Cl. 409/131; 409/214

(57) ABSTRACT

Provided is a tool which is capable of precisely measuring a distance from a reference point such as a mechanical origin to a cutting edge, even where the cutting edge is small in diameter, thereby allowing the cutting edge to be precisely moved to a machining origin which is a machining start position. Targets (12), (13) are provided at a site displaced from a cutting edge (11) which is a machining site to a thicker base side, on the tool designated by numeral (1), for applying machining to a work piece (W). These targets are formed in an irregular shape for acting measuring mediums (Zy), (Zx) such as a probe or an electrode for contact-type measurement, light for optical measurement, or a sonic wave for displacement-type measurement, and further, light required for optical magnification-type stereoscopic vision or optical imaging.

### TECHNICAL FIELD

The present invention relates to a tool and a tool correction method which are capable of appropriately detecting a position of a cutting edge or the like when a tool of a minute diameter is mounted on a spindle of a machine tool such as a machining center or an NC (Numerically Controlled) milling machine.

### BACKGROUND ART

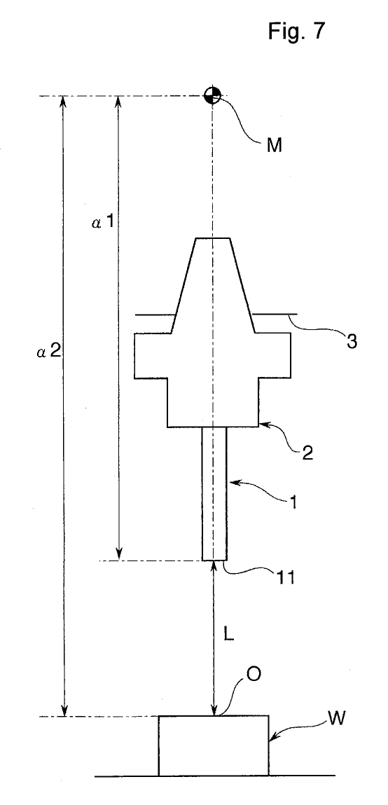

Machining such as drilling or cutting, as shown in FIG. 7, is performed by mounting a tool 1 such as an end mill on a tooling 2, and further, mounting this tooling 2 on a spindle 3 of a processing machinery such as a machining center or a lathe. As the processing machinery also, an NC (Numerically Controlled) machine tool has become prevalent.

In machine tools of this type, in general, a machining origin O is recognized based upon an offset quantity α2 from a mechanical origin M in a mechanical coordinate system; a movement route of a tool, instructed in a machining program created with reference to the machining origin O, is converted into the mechanical coordinate system by employing the offset quantity α2; and movement of the tool 1 is numerically controlled under this mechanical coordinate system. At this time, a machining start distance L, for placing in the machining origin O a cutting edge 11 at the side of the tool 1 that is a machining site for applying machining to a work piece W, is determined according to a relationship between the offset quantity α2 from the mechanical origin M to the machining origin O and a relative distance α1 from the mechanical origin M to the cutting edge 11, namely (α2−α1).

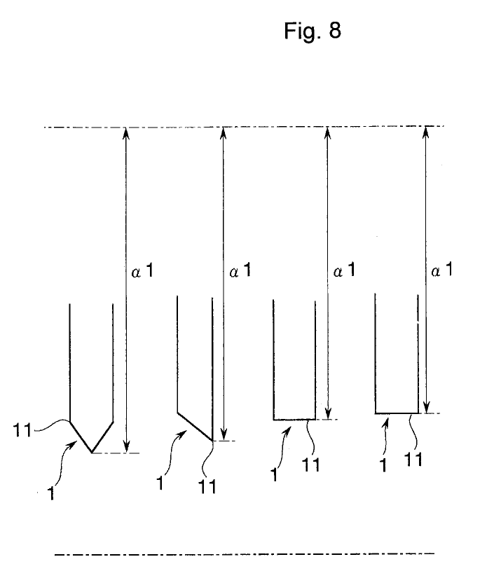

Incidentally, the tooling 2 and the spindle 3 are generally tapered and engaged with each other, and a mount error presents almost no problem, whereas on the tooling 2, as shown in FIG. 8, a variety of tools 1 are mounted according to an object/use thereof, including drilling or cutting, and a solid error or the like exists even if the tools 1 are of the same type, thus allowing the relative distance α1 from the mechanical origin M to the cutting edge 11 to vary, with the tool 1 being mounted on the tooling 2 shown in FIG. 7.

Therefore, if this is handled while a uniform value is defined for each type of the tool 1, the cutting edge 11 cannot be precisely moved to the machining origin O; contact occurs in unintended location; an accidental error emerges in machining depth; or an offset quantity from an orbit goes wrong upon machining of hole(s) or the like, making it difficult to attain precise machining.

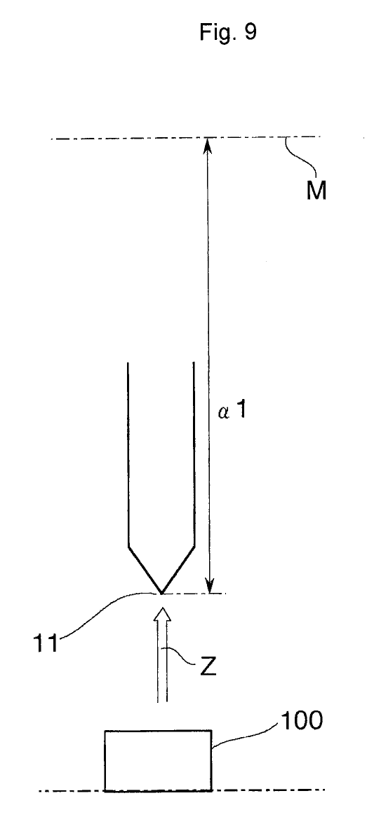

Accordingly, prior to starting mechanical machining, with the tool 1 being mounted on the tooling 2, and further, the mounted tool being mounted on the spindle 3 of the NC processing machinery (or being set at a tool pre-setter or the like which is an artificial machine), a measuring medium Z is acted on the cutting edge 11 from measuring means 100, as shown in FIG. 9, thereby actually measuring the relative distance α1 from a reference point such as the mechanical origin M to a machining site such as the cutting edge 11.

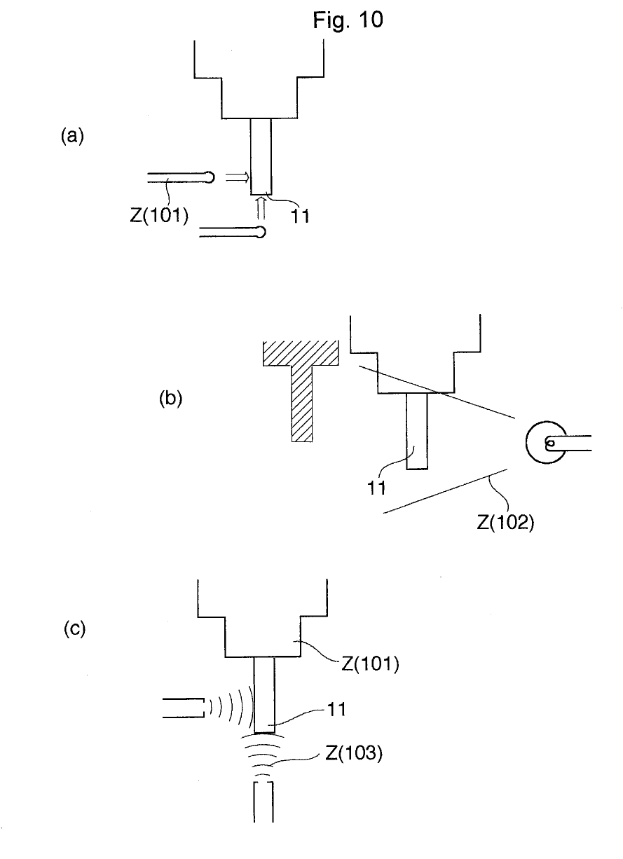

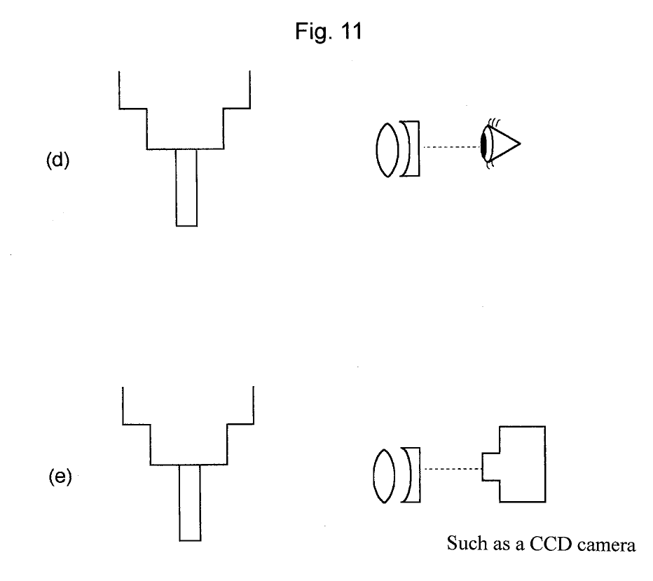

As a technique of acting the measuring medium Z, thereby performing measurement, there is known: a system of contacting a gauge head 101 such as a probe or an electrode which is the measuring medium Z, on the cutting edge 11, and utilizing a contact pressure or energizing at that time to sense a cutting edge position (a contact system), as shown in FIG. 10(a), a system of acting light 102 such as a laser, which is the measuring medium Z, on the cutting edge 11, and detecting a position of the cutting edge by means of an optical shadow thereof (an interference system), as shown in FIG. 10(b); or alternatively, a system of acting an undulation 103 such as a sonic wave or an electromagnetic wave, which is the measuring medium Z, on the cutting edge 11, as shown in FIG. 10(c), and measuring reflection and recurrent reflection thereof by means of a displacement gauge to sense a cutting edge position (a reflection system), etc. Further, FIG. 11(d) shows a case of measurement by optical magnification-type stereoscopic vision; and FIG. 11(e) shows a case of measurement by optical imaging employing a CCD camera, etc., and either of them is one of the techniques in which light is employed as a measuring medium. Patent Document 1 illustrates a part of the above-described optical technique. Furthermore, the foregoing description applies in measurement relative to a radial distance of the tool 1 as well.

[Patent Document 1] Japanese Laid-open Patent Application No 09-300178

### DISCLOSURE OF THE INVENTION

### [Problem(s) to Be Solved by the Invention]

Incidentally, in the recent machine tools in particular, there have been an increasing number of cases in which a tool 1 of a very small diameter is used. However, as a portion of the cutting edge 11 of the tool 1 becomes smaller, the cutting edge strength becomes lower accordingly. Therefore, there is a high possibility that a target to be measured is broken due to a contact pressure of the gauge head 101 in the contact system employing the gauge head 101 such as a probe for the measuring medium Z, and there is a problem that, if the gauge head 101 is an electrode or the like, there occurs electric discharge due to insulation destruction exerted by a slight air gap, and precise measurement becomes difficult. In addition, the optical system employing the light 102 as the measuring medium Z entails a problem that there occurs aberration due to boundary refraction of a target to be measured, and an error is prone to occur in measurement result, and further, the reflection system employing the undulation 103 such as a sonic wave or an electromagnetic wave as the measuring medium Z does not function if a target to be measured fails to meet a predetermined mass, and thus, measurement per se becomes difficult relative to a tool of a very small diameter. Measurement by optical magnification-type stereoscopic vision or measurement by optical imaging also entails a similar problem in that measurement becomes difficult due to a reason that resolution does not increase.

This is a common problem concerning a variety of tools such as rotary blades or non-rotary blades, including an end mill, a drill, and a spring-necked turning tool, and further, is similar to an electrode, etc., for electric discharge machining other than these blades as well.

The present invention has been made in view of the above-described problems, and aims to provide a tool and a tool correction method which are capable of precisely measuring a distance from a reference point such as a mechanical origin to a cutting edge, even in a case where the cutting edge has a small diameter, thereby allowing the cutting edge to be precisely moved to a machining origin which is a machining start point.

### [Means for Solving the Problem(s)]

In order to achieve the above-described object, the present invention provides the following means.

In other words, a tool of the present invention is characterized in that a target formed in an irregular shape such as a concave-convex shape or by marking, etc., for acting a measuring medium such as a probe or an electrode for contact-type measurement, light for optical measurement, or alternatively, a sonic wave for displacement-type measurement, is provided at a site displaced from a machining site to a thick base side, on the tool for applying machining to work pieces.

If an attempt is made to detect a position of a machining site such as a cutting edge by employing the abovementioned measuring instrument that exists, with a tool being set on a machine tool such as an NC machine tool, it is difficult to perform appropriate detection by means of the abovementioned measuring instrument, where the cutting edge or the like is small in diameter in particular. On the other hand, while detection of a machining site such as a cutting edge can be appropriately performed by employing a projector or the like, the projector is intended to actually measure the dimensions of sites of a tool from a shadow projected at an opposite side by irradiating the tool with light, thus making it difficult to bring this projector into the NC machine tool or the like.

Therefore, a distance from a target to a machining site such as a cutting edge is measured in advance by means of a projector or the like, using a tool on which a target measurable by the existing measuring means has been provided, whereby a distance from a reference position to the machining site can be measured indirectly through detection of a target position without a need to detect the machining site on a machine tool such as an NC machine tool. Thus, even if a machining site is small in diameter, as is seen in a cutting edge or the like, it becomes possible to give a precise machining start distance from the machining site to a machining origin. Such a circumstance also applies where measurement is performed with a machining site serving as a starting point on a dummy machine tool such as a tool presetter.

A specific aspect of the present invention includes: providing a thrust face at a large-diameter or wide site displaced from the machining site to the base side on the tool to employ the thrust face as a target in a longitudinal direction or providing a radial face at the large-diameter or wide site displaced from a machining site to the base side on the tool to employ the radial face as a target in a radial direction.

Alternatively, as another aspect of the present invention, it is preferable to apply a marking to the large-diameter or wide site displaced from the machining site to the base side on the tool, employing the marking as the target in the longitudinal direction, or alternatively, to apply a marking to the large-diameter or wide site displaced from the machining site to the base side on the tool, employing the marking as the target in the radial direction.

A method of correction in a longitudinal direction employing the abovementioned tool may execute a first step of measuring a distance in a longitudinal direction from a machining site to a target by employing a projector or the like for the tool; and a second step of measuring a distance in a longitudinal direction from a reference position on a gripping tool to the target, with the tool being mounted on the gripping tool such as tooling, or alternatively, measuring a distance in a longitudinal direction from a reference position on a gripping tool to the target or a distance in a longitudinal direction from a reference position on a machine tool to the target, with the tool being mounted on the gripping tool such as tooling, and further, the gripping tool being mounted on a spindle, thereby directly or indirectly correcting a machining start distance in a longitudinal direction from a machining site on the tool to a machining origin on a work piece. The first step may be executed, with the tool being mounted on the gripping tool such as tooling.

Alternatively, a method of correction in a radial direction employing the abovementioned tool may execute a first step of measuring a distance in a radial direction from a machining site to a target by employing a projector or the like for the tool; and a second step of measuring a distance in a radial direction from a reference position on a gripping tool to the target, with the tool being mounted on the gripping tool such as tooling, or alternatively, measuring a distance in a radial direction from a reference position on a gripping tool to the target or a distance in a radial direction from a reference position on a machine tool to the target, with the tool being mounted on the gripping tool such as tooling, and further, the gripping tool being mounted on a spindle, thereby directly or indirectly correcting a machining start distance in a radial direction from a machining site on the tool to a machining origin on a work piece. Like the foregoing description, the first step may be executed, with the tool being mounted on the gripping tool such as tooling.

### ADVANTAGEOUS EFFECT(S) OF THE INVENTION

With the above-explained structure, the present invention can provide a tool and a tool correction method which are capable of precisely measuring a distance from a reference point such as a mechanical origin to a cutting edge, even if the cutting edge is small in diameter, thereby allowing the cutting edge to be precisely moved to a machining origin which is a machining start point. Even if there could be developed a direct measuring technique which is capable of grasping a very small tip end of a tool, such technique is readily influenced by mechanical vibration. Therefore, the present invention attains an excellent advantageous effect in that stable measurement is possible.

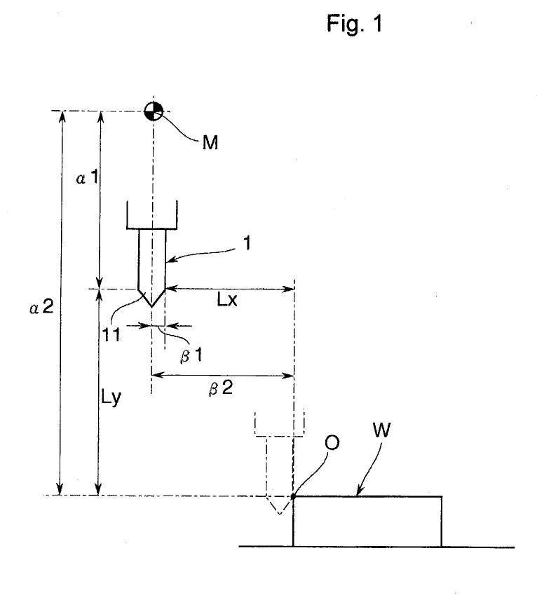

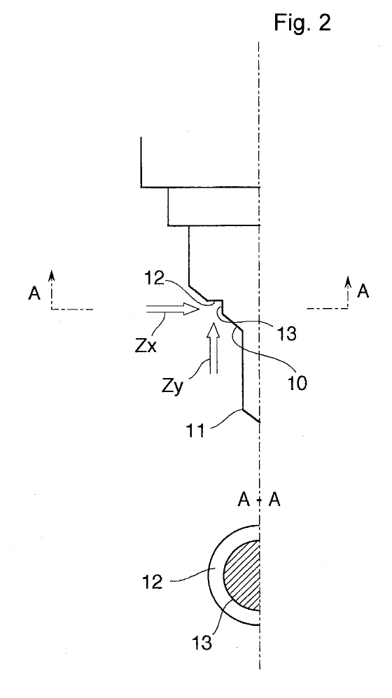

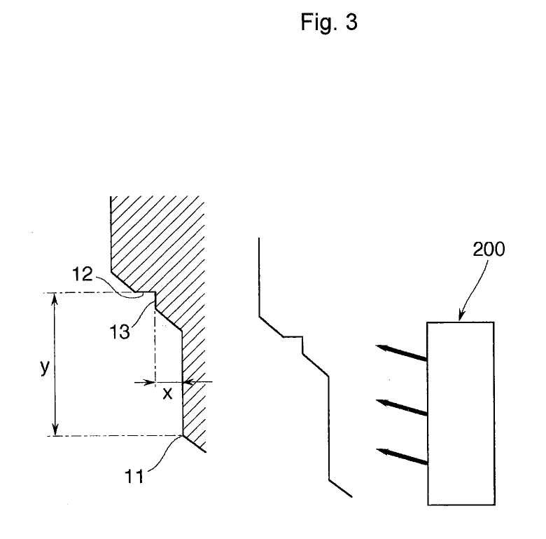

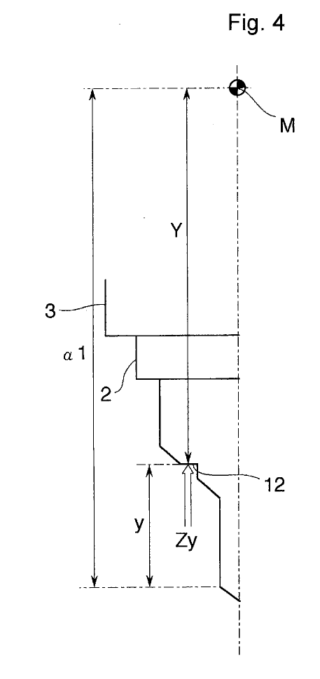

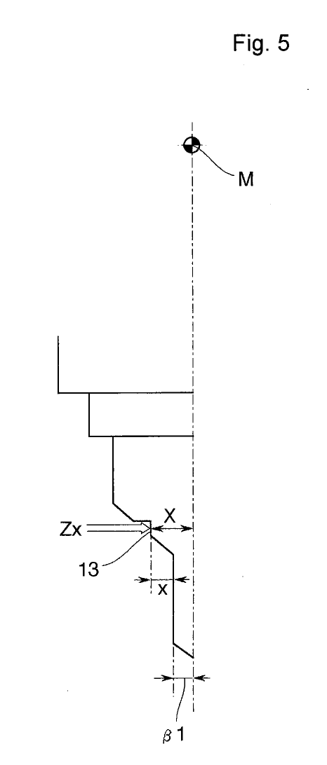

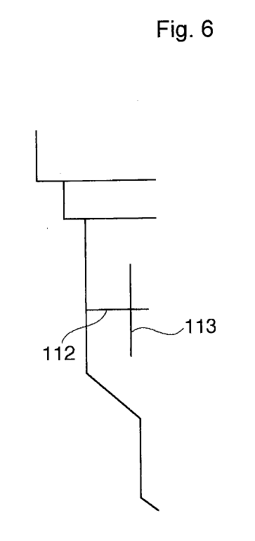

### BRIEF DESCRIPTION OF THE DRAWINGS

[FIG. 1] It is a principal view of an NC machine tool to which one embodiment of the present invention is applied.

[FIG. 2] It is a view showing a tool according to the embodiment.

[FIG. 3] It is a view illustrating a first step according to a method of correcting the tool.

[FIG. 4] It is a view illustrating a second step according to a method of correcting the tool.

[FIG. 5] It is a view illustrating a second step according to a method of correcting the tool.

[FIG. 6] It is a view showing a modified embodiment of the present invention.

[FIG. 7] It is a principal view of an NC machine tool to which a conventional tool is applied.

[FIG. 8] It is an illustrative view of correction of the tool.

[FIG. 9] It is a view showing a method of correcting the tool.

[FIG. 10] It is a view showing a measuring method employed to correct the tool.

[FIG. 11] It is a view showing another measuring method employed to correct the tool.

### BEST MODE FOR CARRYING OUT THE INVENTION

Hereinafter, one embodiment of the present invention will be described referring to the drawings.

A tool of the embodiment is used by mounting it on an NC machine tool such as a machining center. As already exemplarily described with respect to a longitudinal direction, in machines of this type, as shown in FIG. 1, a machining origin O on a work piece W is recognized based upon an offset quantity α2 in a longitudinal direction and an offset quantity β2 from a mechanical origin M in a mechanical coordinate system; a movement route of a tool 1, instructed in a machining program created with reference to the machining origin O, is converted into a mechanical coordinate system by employing the offset quantities α2, β2; and movement of the tool 1 is numerically controlled under this mechanical coordinate system.

At this time, by employing offset quantities α2, β2 from the mechanical origin M to the machining origin O and relative distances α1, β1 from the mechanical origin M to the cutting edge 11, machining start distances Lx, Ly, which are obtained until machining is started after the cutting edge 11 of the tool 1 has been placed in the machining origin O, can be expressed as:

Ly=α2−α1 (1)

in the longitudinal direction; and

Lx=β2−β1 (2)

in the radial direction.

In this case, since α1, β1 include a solid error of the tool 1 or a mount error which can occur when the tool 1 is mounted on a tooling 2, it is desirable that actual measurement be performed with the position of the cutting edges 11 being grasped. As already described, however, if the diameter of the blade becomes a predetermined one or smaller, it becomes difficult to actually measure α1 , β1 by the measuring means 100 of FIG. 9, installed on the machine tool.

Therefore, according to the embodiment, at the side of the tool 1 for applying machining to work pieces W, targets 12, 13 formed in an irregular shape for acting a gauge head 101 such as a probe or an electrode, light 102, or undulation 103, shown in FIG. 10, and further, acting light or the like in FIG. 11, as a measuring medium Zy in the longitudinal direction or a measuring medium Zx in a radial direction, are provided at a site displaced towards a thicker base side from the cutting edge 11 that is a machining site on the tool 1, as shown in FIG. 2, namely at a tapered portion 10 existing between a small-diameter cutting edge portion and a base portion for mounting, in the embodiment.

The target 12 is a thrust face vertical to a longitudinal direction, formed at a site of the base side thicker than the cutting edge 11 that is a working site, the thrust face allowing the measuring medium Zy for measurement in the longitudinal direction to be acted thereon. The target 13 is a radial face made of a predetermined diameter, formed over a predetermined region at a site of the base side thicker than the cutting edge 11 that is a working site, the radial face allowing the measuring medium Zx for measurement in the radial direction to be acted thereon.

In explaining a measuring method, those first measured at a stage before mounting the tool 1 on the machine tool, as shown in FIG. 3, are: a distance y in the longitudinal direction from the cutting edge 11 that is a machining site to the target 12 relative to the tool 1; and a distance x in the radial direction from the cutting edge 11 to the target 13. Although these distances cannot be measured by measuring means 100 shown in FIG. 10, they can be appropriately actually measured by employing a projector 200 or the like, outside of the machine tool. The reference position of the cutting edge 11 is variously different depending upon a tool type or a machining object (such as drilling or boring). Needless to say, the above reference position is not limitative to the illustrative embodiment. The above measurement may be performed prior to mounting the tool 1 on a gripping member 2 such as tooling, or alternatively, may be performed with the tool 1 being mounted on the gripping member 2.

Next, the tool 1 is mounted on the spindle 3 of the NC machine tool via the gripping tool 2, as shown in FIG. 4. In that state, the distance Y in the longitudinal direction from a reference position (for example, mechanical origin M) on the machine tool to the target 12 is measured by employing a measuring medium Zy. As shown in FIG. 5, the distance X in the radial direction from the reference position (for example, mechanical origin M) on the machine tool to the target 13 is measured by employing the measuring medium Zx. For this measurement, the existing measuring means 100 shown in FIG. 9 can be employed as is. In other words, even if the cutting edge 11 is small in diameter and is vulnerable, the targets 12, 13 are sufficient in mass and size, so that: a defect due to a contact pressure exerted when the gauge head 101 is contacted or an electric discharge before contact hardly occurs; boundary refraction can be restrained to the minimum where light 102 is employed; and a target to be measured is sufficiently large even where the undulation 103 is employed, thus making it possible to appropriately achieve a primary effect.

Upon determining the distance Y in the longitudinal direction from the mechanical origin M to the target 12 and the distance X in the radial direction from the mechanical origin M to the target 13, according to the distance y in the longitudinal direction and the distance x in the radial direction from the targets 12, 13, measured previously to the cutting edge 11 that is a machining site, the distance α1 in the longitudinal direction from the mechanical origin M to the cutting edge 11 or its proximity is obtained as:

α1=Y+y (3)

and the distance β1 in the radial distance from the mechanical origin M to the cutting edge 11 is obtained as:

β1=X−x (4)

Thus, these values are used in formulas (1) and (2) on the machine tool of FIG. 1, thereby making it possible to precisely determine a machining start distance Ly in the longitudinal direction from the cutting edge 11 that is a machining site to the machining origin O on the work piece W and a machining start distance Lx in the radial direction.

Presupposing that the NC machine tool in the embodiment is of type of inputting the distance α1 from the mechanical origin M to the cutting edge 11 that is a machining site, for example, where an input value of a tool 1 currently mounted is α1=100 mm from formula (3), the machining start distance Ly from the cutting edge 11 to the machining origin O is obtained as (α2−100) mm from formula (1) by employing an offset quantity from the mechanical origin M to the cutting edge 11 as α2. On the other hand, where an input value of a replacement tool 1 is obtained as 102 mm, by numerically inputting 102 mm, the machining start distance from the cutting edge 11 to the machining origin O is obtained as (α2−102) mm from formula (1), and the machining start distance is corrected by 2 mm.

The above-described procedure is completely similar for radial measurement as well.

As described above, according to the embodiment, targets 12, 13 formed in an irregular shape for acting measuring mediums Zy, Zx such as a probe or an electrode for contact-type measurement, light for optical measurement, or a sonic wave for displacement-type measurement, and further, acting light required for optical magnification-type stereoscopic vision or optical imaging, are provided at a site displaced from the cutting edge 11 that is a machining site to a thicker base side, on the tool 1 for applying machining to the work piece W.

If a distance from the targets 12, 13 to a machining site such as the cutting edge 11 is measured by means of a projector 200 or the like, using the tool 1 having such targets 12, 13, a distance from the reference position (mechanical origin M) to the cutting edge 11 can be indirectly measured through position detection of the targets 12, 13 without a need to detect the cutting edge 11 on the NC machine tool. Thus, even if the cutting edge 11 is small in diameter, it becomes possible to give precise machining start distances Ly, Lx from the cutting edge 11 to the machining origin O, based upon the value measured by employing the measuring means 100 of FIG. 9.

In addition, the targets 12, 13 are thrust faces or radial faces formed in a large-diameter or wide site displaced from the cutting edge 11 to the base side on the tool 1, and such an irregular shape can be readily formed by means of lathe machining or any other technique as required; displacement or deformation hardly occurs, since these targets are sufficiently large in mass or size; and measurement can be performed with the measuring mediums Zy, Zx being reliably acted over an effective range.

Further, the entire steps to be executed may include: a first step of measuring a distance in a longitudinal direction from the cutting edge 11 that is a machining site to the target 12 by employing the projector 200 or the like; and a second step of measuring a distance in a longitudinal direction from the reference position (mechanical origin M) on the machine tool to the target 12, with the tool 1 being mounted on the gripping tool 2 such as tooling, and further, the gripping tool 2 being mounted on the spindle 3. In this way, the distance from the target 12 to the cutting edge 11 is actually measured in advance, and actual measurement on the machine tool is performed with the target 12 serving as a starting point, whereby even if measurement on the machine tool with a hardly-measurable cutting edge 11 serving as a starting point is avoided, it becomes possible to precisely grasp the distance from the cutting edge 11 to the mechanical origin M and appropriately correct a machining start distance in the longitudinal direction from the cutting edge 11 to the machining origin O on the work piece W directly or indirectly.

Similarly, the steps to be executed may include: a first step of measuring a distance in a radial direction from the cutting edge 11 that is a machining site to the target 13 by employing a projector or the like; and a second step of measuring a distance in a radial direction from the reference position (mechanical origin M) on the machine tool to the target 13, with the tool 1 being mounted on the gripping tool 2 such as tooling, and further, the gripping tool 2 being mounted on the spindle 3. In this way, the distance from the target 13 to the cutting edge 11 is actually measured in advance, and actual measurement on the machine tool is performed with the target 13 serving as a starting point, whereby even if measurement on the machine tool with a hardly-measurable cutting edge 11 serving as a starting point is avoided, it becomes possible to precisely grasp the distance from the cutting edge 11 to the mechanical origin M and appropriately correct a machining start distance in the radial direction from the cutting edge 11 to the machining origin O on the work piece W directly or indirectly.

A specific structure of constituent elements is not limitative to only the above-described embodiment.

A measuring medium can also be directly acted without a need to machine a target, for example, if an outer circumference of a base portion larger than a cutting edge in diameter can be utilized as is.

In addition, while, in the embodiment, targets formed in a irregular shape were provided, as shown in FIG. 6, a linear marking 112 along a circumferential direction can be applied to a large-diameter or wide site displaced from a machining site to a base site on a tool, employing the marking 112 as a target in a longitudinal direction and in a radial direction, or alternatively, a marking 113 in an axial direction orthogonal to the marking 112 together therewith can be applied, employing an intersection point between these markings 112 and 113 as a target in a longitudinal direction and in a radial direction.

Of course, the shape of marking or a use mode can be realized by variously modifying it without being limitative thereto. The shape or mode can also be realized by combining types of targets with each other, such as employing marking for a target in a longitudinal direction and for a target in a radial direction utilizing an outer circumferential portion as is, which is larger than a cutting edge of a tool in diameter, for example.

Further, data input to the NC machine tool in the above-described embodiment is merely provided as one example, and various actions such as inputting a distance from a target to a cutting edge, for example, can be taken according to types of machine tools or programs.

Moreover, while, in the embodiment, a distance in a longitudinal direction from a reference position on a machine tool to a target was measured, a distance in a longitudinal direction from a reference position (gauge reference point, for example) on a gripping tool such as tooling to a target may be measured.

Furthermore, while, in the embodiment, a distance in a longitudinal direction from a reference position on a machine tool to a target was measured, with a tool being mounted on a gripping tool such as tooling, and further, the gripping tool being mounted on a spindle, in a case where measurement is performed with a machining site serving as a starting point on a dummy machine tool such as a tool presetter, the gripping tool may be mounted on a spindle of the machine tool after a distance in a longitudinal direction from a reference position (gauge reference point, for example) on the gripping tool to a target is measured at a stage at which a tool is mounted on the gripping tool such as tooling.

Other structures or procedures and the like can be variously modified without departing from the gist of the present invention.

### INDUSTRIAL APPLICABILITY

According to the present invention described in detail hereinbefore, it becomes possible to provide a tool and a tool correction method which are capable of precisely measuring a distance from a reference point such as a mechanical origin to a cutting edge, even if the cutting edge is small in diameter, thereby allowing the cutting edge to be precisely moved to a machining origin which is a machining start point.

1. A tool in which a target formed in an irregular shape or by means of marking for acting a measuring medium such as a probe or an electrode for contact-type measurement, light for optical measurement, or a sonic wave for displacement-type measurement, is provided at a site displaced from a machining site to a thick base side, on the tool for applying machining to work pieces.

2. The tool according to claim 1, wherein a thrust face is provided at a large-diameter or wide site displaced from the machining site to the base side on the tool, and the thrust face is employed as a target in a longitudinal direction.

3. The tool according to claim 1, wherein a radial face is provided at the large-diameter or wide site displaced from a machining site to the base side on the tool, and the radial face is employed as a target in a radial direction.

4. The tool according to claim 1, wherein a marking is applied to the large-diameter or wide site displaced from the machining site to the base side on the tool, and the marking is employed as the target in the longitudinal direction.

5. The tool according to claim 1, wherein a marking is applied to the large-diameter or wide site displaced from the machining site to the base side on the tool, and the marking is employed as the target in the radial direction.

6. A tool correction method, comprising:
a first step of measuring a distance in a longitudinal direction from a machining site to a target by employing a projector or the like for the tool according to claim 1; and
a second step of measuring a distance in a longitudinal direction from a reference position on a gripping tool to the target with the tool being mounted on the gripping tool such as tooling, or alternatively, measuring a distance in a longitudinal direction from a reference position on a gripping tool to the target or a distance in a longitudinal direction from a reference position on a machine tool to the target, with the tool being mounted on the gripping tool such as tooling, and further, the gripping tool being mounted on a spindle, thereby directly or indirectly correcting a machining start distance in a longitudinal direction from a machining site on the tool to a machining origin on a work piece.

7. (canceled)

8. A tool correction method, comprising:
a first step of measuring a distance in a longitudinal direction from a machining site to a target by employing a projector or the like for the tool according to claim 4; and
a second step of measuring a distance in a longitudinal direction from a reference position on a gripping tool to the target with the tool being mounted on the gripping tool such as tooling, or alternatively, measuring a distance in a longitudinal direction from a reference position on a gripping tool to the target or a distance in a longitudinal direction from a reference position on a machine tool to the target, with the tool being mounted on the gripping tool such as tooling, and further, the gripping tool being mounted on a spindle, thereby directly or indirectly correcting a machining start distance in a longitudinal direction from a machining site on the tool to a machining origin on a work piece.

9. A tool correction method, comprising:
a first step of measuring a distance in a radial direction from a machining site to a target by employing a projector or the like for the tool according to claim 1; and
a second step of measuring a distance in a radial direction from a reference position on a gripping tool to the target with the tool being mounted on the gripping tool such as tooling, or alternatively, measuring a distance in a radial direction from a reference position on a gripping tool to the target or a distance in a radial direction from a reference position on a machine tool to the target, with the tool being mounted on the gripping tool such as tooling, and further, the gripping tool being mounted on a spindle, thereby directly or indirectly correcting a machining start distance in a radial direction from a machining site on the tool to a machining origin on a work piece.

10. A tool correction method, comprising:
a first step of measuring a distance in a radial direction from a machining site to a target by employing a projector or the like for the tool according to claim 3; and
a second step of measuring a distance in a radial direction from a reference position on a gripping tool to the target with the tool being mounted on the gripping tool such as tooling, or alternatively, measuring a distance in a radial direction from a reference position on a gripping tool to the target or a distance in a radial direction from a reference position on a machine tool to the target, with the tool being mounted on the gripping tool such as tooling, and further, the gripping tool being mounted on a spindle, thereby directly or indirectly correcting a machining start distance in a radial direction from a machining site on the tool to a machining origin on a work piece.

11. A tool correction method, comprising:
a first step of measuring a distance in a radial direction from a machining site to a target by employing a projector or the like for the tool according to claim 5; and
a second step of measuring a distance in a radial direction from a reference position on a gripping tool to the target with the tool being mounted on the gripping tool such as tooling, or alternatively, measuring a distance in a radial direction from a reference position on a gripping tool to the target or a distance in a radial direction from a reference position on a machine tool to the target, with the tool being mounted on the gripping tool such as tooling, and further, the gripping tool being mounted on a spindle, thereby directly or indirectly correcting a machining start distance in a radial direction from a machining site on the tool to a machining origin on a work piece.

12. A tool correction method, comprising:
a first step of measuring a distance in a longitudinal direction from a machining site to a target by employing a projector or the like for the tool according to claim 2; and
a second step of measuring a distance in a longitudinal direction from a reference position on a gripping tool to the target with the tool being mounted on the gripping tool such as tooling, or alternatively, measuring a distance in a longitudinal direction from a reference position on a gripping tool to the target or a distance in a longitudinal direction from a reference position on a machine tool to the target, with the tool being mounted on the gripping tool such as tooling, and further, the gripping tool being mounted on a spindle, thereby directly or indirectly correcting a machining start distance in a longitudinal direction from a machining site on the tool to a machining origin on a work piece.
